(19) United States
(12) Patent Application Publication
(10) Pub. No.: US 2007/0095977 A1
(43) Pub. Date: May 3, 2007

(54) Mesh fender for protecting an aircraft against damage from foreign objects

(75) Inventor: Jonathan W. Gabrys, Downingtown, PA (US)

Correspondence Address: LEE & HAYES, PLLC, 421 W. RIVERSIDE AVE., SUITE 500, SPOKANE, WA, 99201, US

(73) Assignee: The Boeing Company

(21) Appl. No.: 11/263,511

(22) Filed: Oct. 31, 2005

(51) Int. Cl. B64C 25/34

(52) U.S. Cl. 244/103 R

(57) ABSTRACT

Aircraft including an airframe and landing gear including a wheel rotatably connected to the airframe. The landing gear further includes a fender connected to the airframe adjacent and generally above the wheel wherein the fender comprises a mesh having a plurality of openings.

### BACKGROUND OF THE INVENTION

The present invention relates to aircraft and, more particularly, to aircraft having a mesh fender for protecting the aircraft against foreign object damage.

Conventional aircraft are sometimes damaged when foreign objects laying on the runway are picked up by wheels of the aircraft during taxi and thrown at an airframe of the aircraft by the taxiing wheels. That is, when the aircraft wheels roll over debris, the debris is sometimes propelled toward the airframe as a result of, for example, being pinched between an edge of the wheel and the runway or being temporarily gripped by the wheel and then released toward the airframe. Examples of foreign objects are parts that have fallen off other aircraft and separated pieces of the runway.

One potential solution for protecting aircraft from foreign object damage is to remove foreign objects from the paths of taxiing aircraft. Although foreign object removal is an initiative at most airports, foreign objects are still often encountered by aircraft. Thus, efforts to remove all foreign objects cannot be relied on to protect aircraft from foreign object damage.

Another potential solution for protecting aircraft from foreign object damage is to make a skin of the airframe stronger than conventional airframe skins by making it of a stronger material and/or by making the skin thicker. However, stronger skin materials and/or thicker skins are undesirable because they are prohibitively costly and heavy.

### BRIEF SUMMARY OF THE INVENTION

The present invention relates to aircraft comprising an airframe and landing gear including a wheel rotatably connected to the airframe. The landing gear further includes a fender connected to the airframe adjacent and generally above the wheel wherein the fender comprises a mesh having a plurality of openings.

In another aspect, the present invention relates to a fender for protecting a wheeled vehicle from damage caused by foreign objects propelled by a wheel of the vehicle. The fender comprises a mesh having a plurality of openings and is configured to connect to the vehicle adjacent and generally above the wheel.

In yet another aspect, the present invention relates to a method for protecting a wheeled vehicle from foreign objects propelled by a vehicle wheel. The method comprises positioning a mesh fender adjacent and generally above a vehicle wheel to block foreign objects propelled by the wheel. The fender has a plurality of openings.

Other aspects of the present invention will be in part apparent and in part pointed out hereinafter.

### BRIEF DESCRIPTION OF THE DRAWINGS

FIG. 1 is a perspective of an aircraft including landing gear having a fender according to a first embodiment of the present invention.

FIG. 2 is a perspective of the landing gear according to the present invention.

FIG. 3 is a perspective of landing gear including a fender according to a second embodiment of the present invention.

FIG. 4 is a perspective of landing gear including a fender according to a third embodiment of the present invention.

FIG. 5 is a perspective of landing gear including a fender according to a fourth embodiment of the present invention.

FIG. 6 is a perspective of landing gear including a fender according to a fifth embodiment of the present invention.

Corresponding reference characters indicate corresponding parts throughout the several views of the drawings.

### DETAILED DESCRIPTION OF THE INVENTION

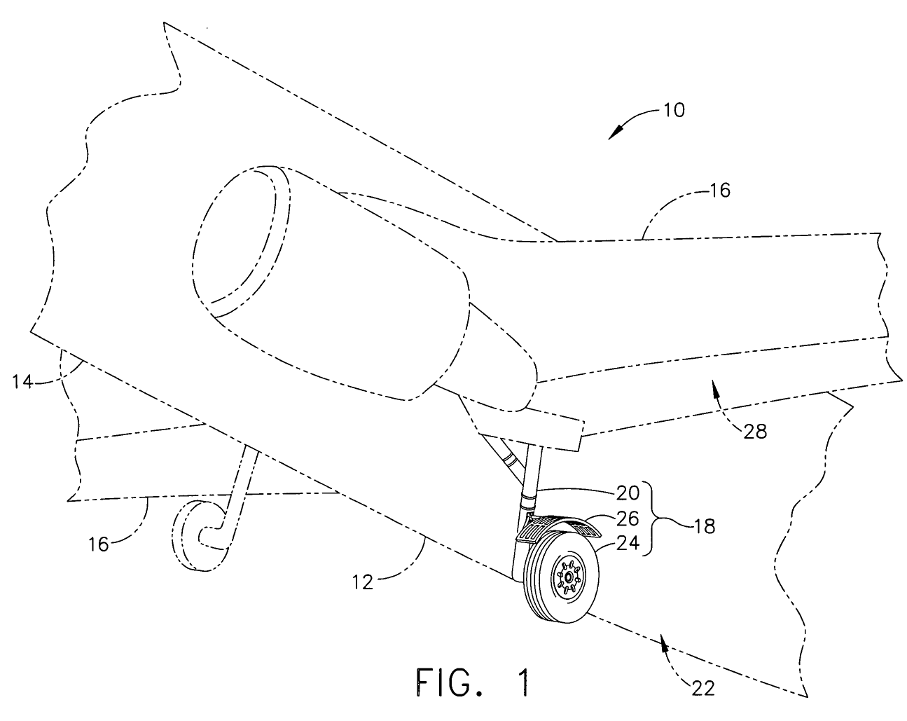

Referring to the figures, and more particularly to FIG. 1, an aircraft according to a first embodiment of the present invention is designated in its entirety by reference number 10. The aircraft 10 comprises an airframe 12 including a fuselage 14 and opposing wings 16 extending laterally from the fuselage. The aircraft 10 further comprises a landing gear assembly 18 including a strut 20 connected to an underside 22 of the airframe 12, a wheel 24 rotatably connected to the strut, and a fender 26 connected to the strut adjacent and generally above the wheel. The fender 26 is positioned between the wheel 24 and the airframe 12 to protect the airframe from foreign objects propelled toward the airframe by the wheel. The landing gear assembly 18 may be directly connected to an underside 28 of one of the wings 16. The aircraft 10 may include one or more (not shown) landing gear assemblies 18 connected to the wings 16 and/or fuselage 14. Each landing gear assembly 18 may include more than one wheel 24. For example, in one embodiment (not shown), a landing gear assembly includes two or more wheels mounted side-by-side and/or in tandem rotatably connected to a common strut between the wheels. In embodiments having such a multi-wheel landing gear assembly, a common fender may be positioned over the wheels or a separate fender may be positioned over each wheel. The fender 26 protects the aircraft 10 from damage caused by foreign objects “F” propelled toward the airframe 12 from the wheels 24. Although the fender 26 is described as being part of an aircraft 10, the fender may be part of other vehicles without departing from the scope of the present invention. For example, the fender 26 may be positioned over a wheel of an automobile (not shown).

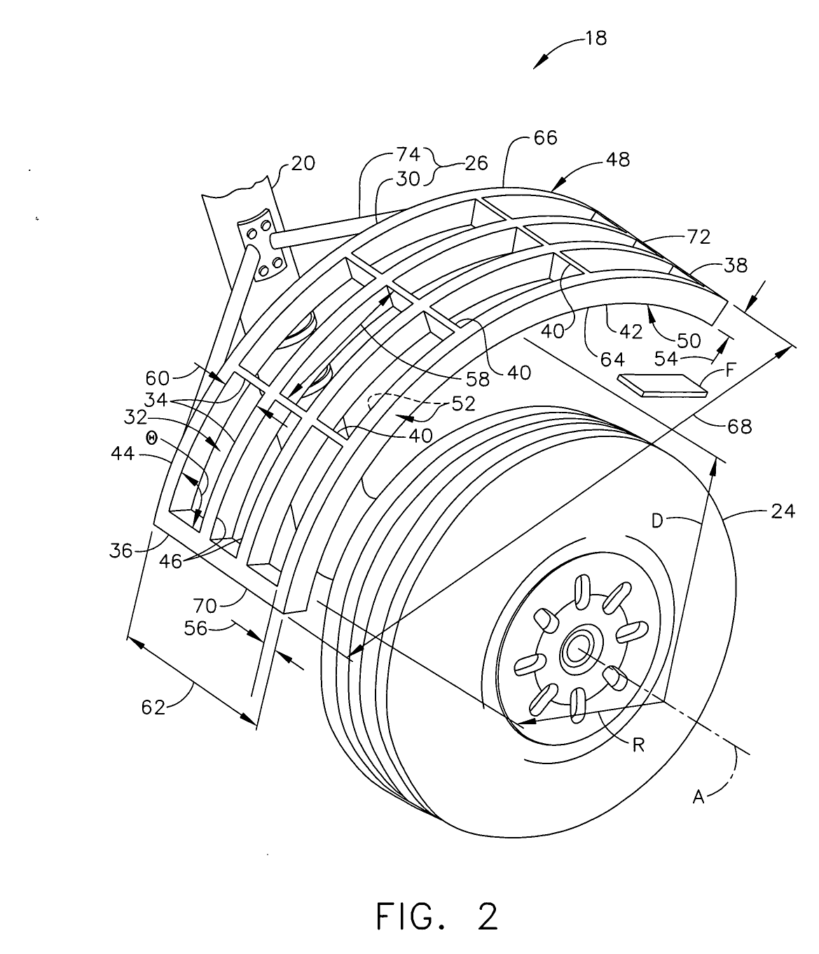

As shown in FIG. 2, the fender 26 forms a mesh 30 having a plurality of openings 32. Such a fender is said to be “vented.” There are many benefits to having a vented fender 26. One benefit of having a vented fender 26 is weight reduction. That is, the fender 26 weighs less with the openings 32 than it would if it were made of the same material(s) but did not have openings. Another benefit of having a vented fender 26 is a reduction in drag compared to some solid fenders. Yet another benefit of having a vented fender 26 is that maintenance personnel can inspect the wheel 24 through the fender with relative ease. The mesh 30 includes a plurality of elongate members 34 forming the openings 32 between them. In one embodiment, the elongate members 34 may be integrally formed or formed by connecting separate components together. In one embodiment, the elongate members 34 include a foremost lateral member 36, a rearmost lateral member 38, and one or more intermediate lateral members 40. The elongate members 34 further include a leftmost longitudinal member 42, a rightmost longitudinal member 44, and one or more intermediate longitudinal members 46 extending generally parallel to each other between the foremost and rearmost lateral members 36, 38. The lateral members 36, 38, 40 extend generally parallel to each other between the leftmost and rightmost longitudinal members 42, 44. In one embodiment, each lateral member 36, 38, 40 meets each longitudinal member 42, 44, 46 at an angle θ of about 90°, but the elongate members 34 may meet at other angles θ without departing from the scope of the present invention. The intermediate lateral members 40 intersect the intermediate longitudinal members 46. The mesh 30 may be configured in other ways without departing from the scope of the present invention. For example, in one embodiment (not shown), elongate members crisscross along diagonals. In another embodiment (not shown), the members 34 form a honeycomb arrangement by forming a plurality of hexagons having common sides.

Whichever mesh 30 configuration is used, the elongate members 34 should be shaped and spaced from each other by distances large enough to allow personnel to easily inspect the underlying landing gear. As will be appreciated by those skilled in the art, variables affecting mesh 30 material, shape, dimensions, and positioning include materials, shapes, sizes, and velocities of foreign objects F expected to be propelled toward the airframe 12. For example, the mesh 30 should be made stronger when heavier objects made of harder materials are expected to be hurled at higher speeds toward the airframe 12. The mesh 30 may be tailored to ensure that foreign objects F of particular sizes and shapes will not pass through the mesh. The mesh 30 may also be tailored to allow certain foreign objects F to pass through the mesh in a controlled manner. For example, the mesh 30 may be shaped and made of a material allowing foreign objects F of a particular material and within a particular size hurled toward the airframe 12 at a particular velocity to break through the mesh as a whole or pass through the mesh after being broken into pieces by the mesh. The mesh 30 is effective to protect the airframe 12 even when the foreign object F passes through the mesh because the mesh decreases the kinetic energy of the object as the object passes through so that the airframe is not damaged. If the mesh 30 breaks while slowing the object F, the mesh 30 or entire fender 26 can be replaced during maintenance.

Each elongate member 34 has a top 48, a bottom 50, and opposing sides 52. Although the elongate members 34 may have other heights 54 extending between their respective tops 48 and bottoms 50 without departing from the scope of the present invention, in one embodiment each elongate member has a height between about 1 centimeter and about 8 centimeters. Although the elongate members 34 may have other widths 56 without departing from the scope of the present invention, in one embodiment each elongate member has a width of between about 0.30 centimeters and about 1.30 centimeters. The elongate members 34 may have various height-to-width ratios without departing from the scope of the present invention. For example, in one embodiment each member 34 has a height-to-width ratio of at least 2:1 and in another embodiment the ratio is at least 4:1 or more. The mesh openings 32 can have various dimensions without departing from the scope of the present invention. For example, in one embodiment each opening 32 has a length 58 of between about 10 centimeters and about 30 centimeters and a width 60 of between about 2 centimeters and about 13 centimeters.

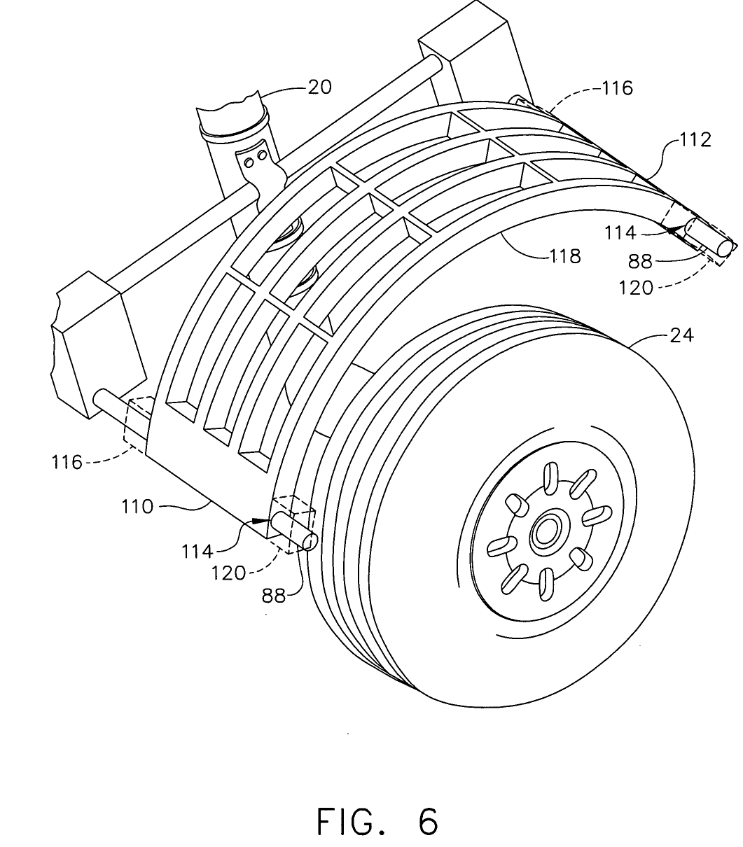

Although the mesh 30 may be made of other materials without departing from the scope of the present invention, in one embodiment the mesh is made of stainless steel. Primary considerations for selecting mesh 30 material include fender weight and strength. The mesh 30 may also be made of more than one material. For example, in one embodiment the foremost and rearmost lateral members 36, 38 are made of a material, such as steel, that is more rigid than a material, such as aluminum, that the intermediate lateral members 40 and longitudinal members 42, 44, 46 are made of. In this embodiment, the more rigid members 36, 38 resist deformation to provide framing support to the mesh 30 while the less rigid members 40, 42, 44, 46 allow a predetermined higher amount of deformation than the more rigid members when hit with a foreign object F to absorb the kinetic energy of the object. In addition, the foremost and the rearmost lateral members 36, 38 may be shaped to be stronger, such as by forming tubes (shown in FIG. 6).

In one embodiment, the mesh 30 is curved and has an inner radius of curvature R adapted for receiving the wheel 24. Although the mesh 30 may have other radii of curvature R, in one embodiment the mesh has a radius of curvature of between about 20 centimeters and about 75 centimeters. The radii of curvature R may be equal to a distance D between a rotation axis A of the wheel 24 and the mesh 30. Although the mesh 30 may have other widths 62 extending between a left side 64 of the mesh and a right side 66 of the mesh, in one embodiment the mesh has a width of between about 2 centimeters and about 13 centimeters. Although the mesh 30 may have other lengths 68 extending between a forward end 70 of the mesh and an aft end 72 of the mesh, in one embodiment the mesh has a length of between about 10 centimeters and about 30 centimeters. In one embodiment, the mesh 30 is generally cylindrical to permit replacement of the wheel 24 without interference from the fender 26. One of the variables determining mesh width 62, length 68, shape, and positioning is desired coverage area. That is, the fender 26 is be sized, shaped, and positioned to protect a predetermined portion of the aircraft 10 above the mesh 30. For example, in one embodiment the primary purpose of the fender 26 is to protect a particularly sensitive portion (not identified in the figures) of the underside 28 of the wing that is generally above and behind the fender. Thus, in this embodiment, the fender 26 may be shifted rearward, made shorter on the forward end 70, and/or made longer on the aft end 72. Similarly, the width 62 of the fender 26 can be tailored and/or the fender can be laterally shifted to ensure protection of a predetermined portion of the aircraft 10.

The fender 26 may be configured in various ways for connection to the airframe 12. For example, as shown in FIG. 2, the mesh 30 may be connected to the strut 20 by way of one or more links 74. The links 74 can be connected to the mesh 30 and the strut 20 in a variety of ways without departing from the scope of the present invention. For example, the links 74 can be welded or bolted to the strut 20 and mesh 30. In one embodiment, the links 74 are integrally formed with the mesh 30. It is contemplated that the strut-side longitudinal mesh member 44 may be made of a stronger material than the other longitudinal members 42, 46 to ensure a strong connection between the mesh 30 and the strut 20.

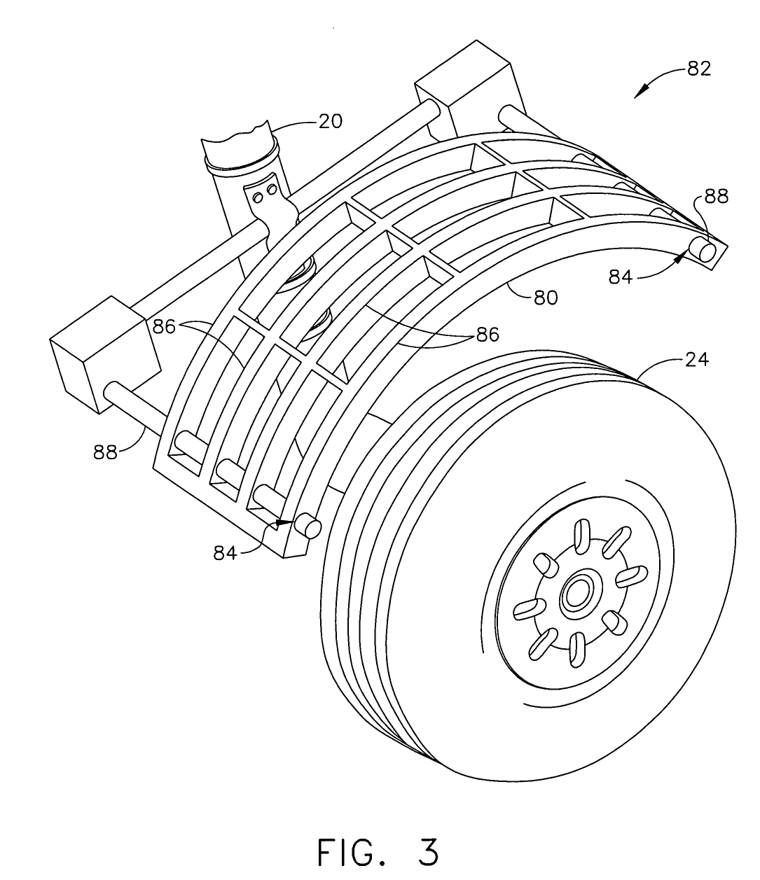

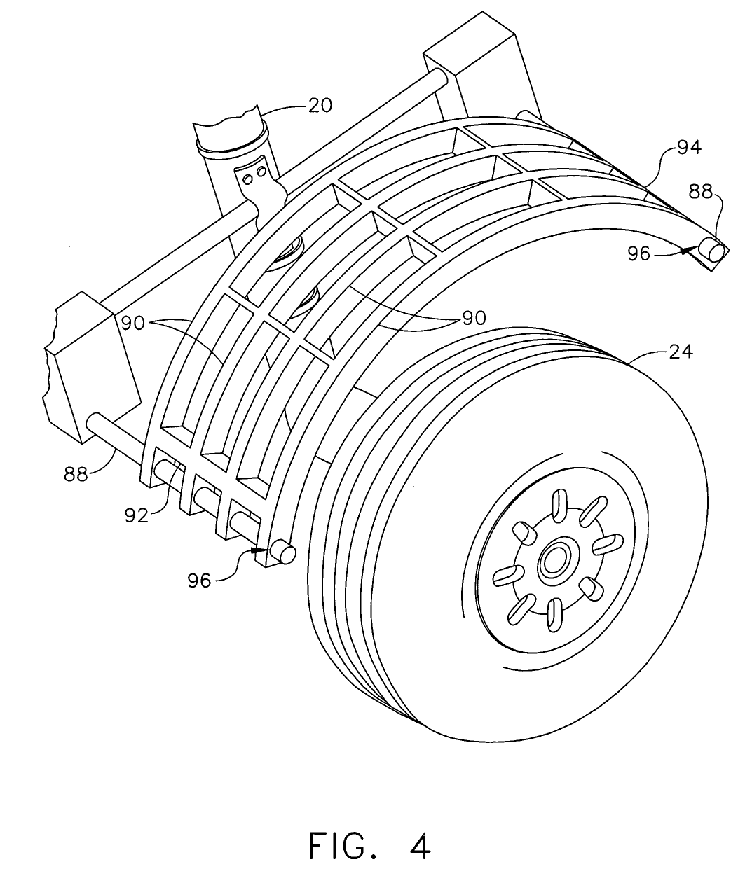

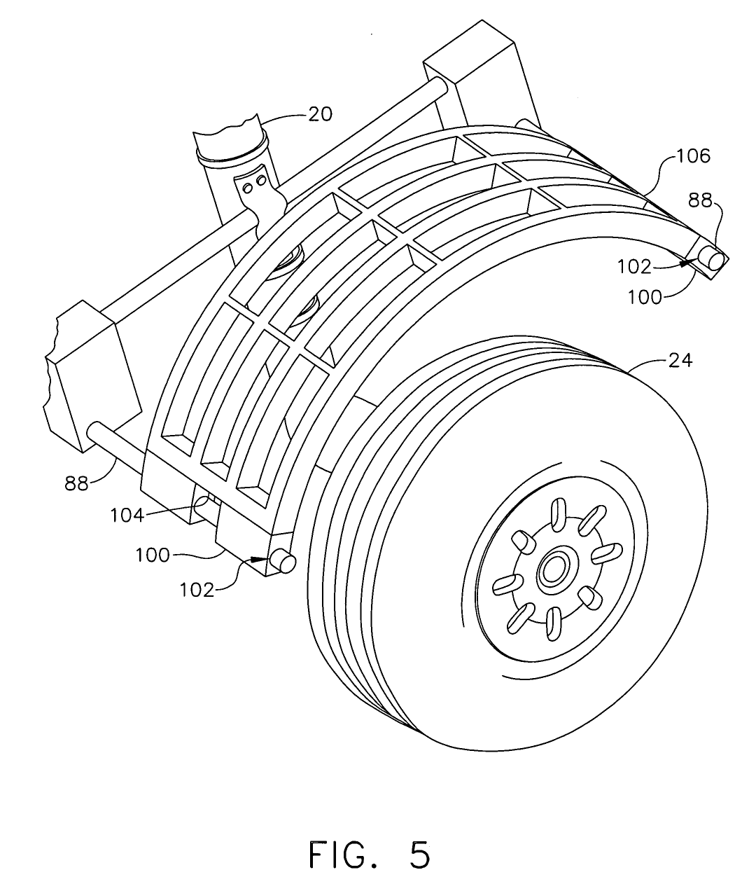

FIG. 3 shows an embodiment of the present invention wherein a mesh 80 of a fender 82 includes holes 84 in longitudinal members 86 to receive support bars 88 that are connected to a strut 20. FIG. 4 shows an embodiment of the present invention wherein the longitudinal members 90 extend longitudinally in front of a foremost lateral member 92 and behind a rearmost lateral member 94 and have holes 96 formed in the extended portions for receiving the support bars 88. When holes 84, 96 are formed in longitudinal members 86, 90 for receiving the support bars 88, it is contemplated that the longitudinal members may be reinforced or made stronger around the holes to strengthen the mesh-to-strut connection. FIG. 5 shows an embodiment of the present invention wherein one or more brackets 100 having cavities 102 are mounted on a foremost lateral member 104 and a rearmost lateral member 106 for receiving the support bars 88. FIG. 6 shows an embodiment of the present invention wherein a foremost lateral member 110 and a rearmost lateral members 112 each form a sleeve having a cavity 114 for receiving the support bars 88. In each embodiment wherein the mesh is connected to support bars 88, adjustable or immovable inside collars 116 can be positioned on the support bars inside of the mesh 118 (i.e., on a side of the mesh adjacent the strut 20) and removable or permanent outside collars 120 can be positioned on the support bars outside of the mesh (i.e., on a side of the mesh opposite the strut 20). Adjustable inside collars 116 allow flexibility in mesh 118 positioning in the lateral direction. Removable outside collars 120 facilitate mesh 118 installation, removal for replacement, and temporary removal for, for example, a detailed analysis of the wheel 24 by maintenance personnel. As will be appreciated by skilled artisans, the collars 116, 120 can be any of many types of securing arrangements. For example, the collars 116, 120 can include pins that are secured in holes (not shown) in the bars 88 to fasten the mesh 118 in place.

The aircraft may be configured so the landing gear assembly is retractable (not shown in detail) into the airframe to improve aerodynamic characteristics of the aircraft during flight between take-off and landing. In one embodiment, the fender is positioned close to the wheel to allow retrofit or manufacture of the fender on conventional retractable aircraft landing gear assemblies. In one embodiment (not shown in detail), the fender is movable, such as pivotable, with respect to the landing gear strut to facilitate retraction and storage of the landing gear assembly in the airframe when retracted.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. Aircraft comprising:
an airframe; and
landing gear including:
a wheel rotatably connected to the airframe; and
a fender connected to said airframe adjacent and generally above said wheel, said fender comprising a mesh having a plurality of openings.

2. Aircraft as set forth in claim 1 wherein said mesh is curved and has an inner radius of curvature adapted for receiving said wheel.

3. Aircraft as set forth in claim 1 wherein the mesh is made of stainless steel.

4. Aircraft as set forth in claim 1 wherein said mesh includes:
a plurality of substantially parallel first elongate members; and
a plurality of substantially parallel second elongate members;
wherein at least one of the first members intersects at least one of the second members.

5. Aircraft as set forth in claim 4 wherein the first elongate members are integrally formed with the second elongate members.

6. Aircraft as set forth in claim 4 wherein each first elongate member meets each second elongate member at an angle of about 90°.

7. Aircraft as set forth in claim 4 wherein each elongate member has a height extending between a top of the member and a bottom of the member and a width extending between opposing sides of the member and the height of each member is at least twice its width.

8. Aircraft as set forth in claim 1 wherein said mesh includes:
a plurality of longitudinal members extending in a fore/aft direction of the vehicle when the mesh is connected to the vehicle; and
a plurality of lateral members extending in a side-to-side direction of the vehicle when the mesh is connected to the vehicle;
wherein at least one of the longitudinal members intersects at least one of the lateral members.

9. Aircraft as set forth in claim 8 wherein each longitudinal member and each lateral member has a height extending between a top of the member and a bottom of the member and a width extending between opposing sides of the member and the height of each member is at least twice its width.

10. Aircraft as set forth in claim 8 wherein the longitudinal members are integrally formed with the lateral members.

11. Aircraft as set forth in claim 1 further comprising:
a strut connected to said airframe, said wheel being rotatably connected to the strut and said fender being connected to said strut.

12. Aircraft as set forth in claim 11 wherein said strut, wheel, and fender are part of a landing gear of the vehicle and the landing gear is retractable into said airframe.

13. A fender for protecting a wheeled vehicle from damage caused by foreign objects propelled by a wheel of the vehicle, said fender comprising:
a mesh having a plurality of openings;
wherein said fender is configured to connect to said vehicle adjacent and generally above said wheel.

14. A fender as set forth in claim 13 wherein said mesh is curved and has an inner radius of curvature adapted for receiving said wheel.

15. A fender as set forth in claim 13 wherein said mesh includes:
a plurality of substantially parallel first elongate members; and
a plurality of substantially parallel second elongate members;
wherein at least one of the first members intersects at least one of the second members.

16. A fender as set forth in claim 13 wherein said mesh includes:
a plurality of longitudinal members extending in a fore/aft direction of the vehicle when the mesh is connected to the vehicle; and
a plurality of lateral members extending in a side-to-side direction of the vehicle when the mesh is connected to the vehicle;
wherein at least one of the longitudinal members intersects at least one of the lateral members.

17. A method for protecting a wheeled vehicle from foreign objects propelled by a vehicle wheel, said method comprising positioning a mesh fender adjacent and generally above each vehicle wheel to block foreign objects propelled by the respective wheel, wherein said fender has a plurality of openings.
